(19) United States
(12) Patent Application Publication
(10) Pub. No.: US 2026/0224940 A1
(43) Pub. Date: Aug. 6, 2026

(54) LIMB EXERCISE DEVICE

(71) Applicant: AI REHAB LIMITED, Lytham St Annes (GB)

(72) Inventor: Shameem Anthony Carl Martin SAMPATH, Lytham (GB)

(21) Appl. No.: 19/047,067

(22) Filed: Feb. 6, 2025

Related U.S. Application Data
(63) Continuation of application No. 17/909,383, filed on Mar. 5, 2021, now abandoned.

(30) Foreign Application Priority Data
Mar. 10, 2020 (GB) 2003437.7

(51) Int. Cl. A63B 22/20; A63B 24/00

(52) U.S. Cl. CPC A63B 22/20; A63B 24/0062; A63B 2208/0247; A63B 2220/13; A63B 2220/20; A63B 2220/52; A63B 2220/805; A63B 2220/833

(57) ABSTRACT

There is provided a limb exercise device comprising: a force sensor configured to determine a weight applied to the device; a sliding component configured to facilitate the sliding movement of the device along a separate surface, wherein the separate surface is a surface that is separate to the device, wherein the sliding component comprises a part of an external housing of the device; a device movement sensor configured to determine a movement of the device on the separate surface; a limb position sensor configured to determine a position, in at least one dimension, of a limb of a user positioned above or adjacent to the device; and an output device configured to output an indication in dependence on a signal from at least one of: the force sensor, the device movement sensor and the limb position sensor.

### FIELD OF THE INVENTION

Embodiments of the present invention relate to a limb exercise device. In particular, though without prejudice to the foregoing, certain examples of the disclosure relate to a device, system, method of using a device and a computer program for controlling a device for performing and monitoring leg exercises.

### BACKGROUND TO THE INVENTION

It is desirable for a patient having undergone knee surgery to perform leg exercises so as to aid the rehabilitation process. Furthermore, it is desirable for a patient to perform leg exercises for training and “prehabilitation” purposes, for example prior to undergoing knee surgery.

Existing devices may facilitate a user performing leg exercises by providing means for performing the leg exercises. Typically, such existing devices must be attached to a limb of the user performing the exercise. The result can be a cumbersome device that can negatively affect the user's ability to perform said exercises because it is attached to the user's limb. In addition, existing devices may not have the functionality to track the limb when the exercise is performed, which prevents the device from being able to determine whether an exercise has been correctly performed. Furthermore, existing devices may not provide functionality for monitoring movement of the device itself, which may also prevent the device from being able to determine whether an exercise has been correctly performed.

The listing or discussion of any prior-published document or any background in this specification should not necessarily be taken as an acknowledgement that the document or background is part of the state of the art or is common general knowledge. One or more aspects/embodiments of the present disclosure may or may not address one or more of the background issues.

### BRIEF DESCRIPTION OF VARIOUS EMBODIMENTS OF THE INVENTION

The present invention is as set out in the independent claims.

In an aspect, there is provided a limb exercise device comprising: a force sensor configured to determine a weight applied to the device; a sliding component configured to facilitate the sliding movement of the device along a separate surface, wherein the separate surface is a surface that is separate to the device, wherein the sliding component comprises a part of an external housing of the device; a device movement sensor configured to determine a movement of the device on the separate surface; a limb position sensor configured to determine a position, in at least one dimension, of a limb of a user positioned above or adjacent to the device; and an output device configured to output an indication in dependence on a signal from at least one of: the force sensor, the device movement sensor and the limb position sensor.

The sliding component may be configured to facilitate at least one of: a translational movement of the device along the separate surface and a rotational movement of the device on the separate surface.

The device movement sensor may be configured to determine at least one of: a translational movement of the device on the separate surface and a rotational movement of the device on the separate surface.

The limb exercise device may comprise a limb orientation sensor configured to determine an orientation of the limb of the user.

The limb exercise device may comprise a limb gesture sensor configured to determine a gesture of the limb of the user.

At least two of: the limb position sensor, the limb orientation sensor and/or the limb gesture sensor may be implemented on a common sensor.

At least one of: the device movement sensor, the limb position sensor, the limb orientation sensor and the limb gesture sensor, may be a sensor configured to transmit radiation and to receive reflected radiation from the limb.

The device movement sensor may comprise an optical sensor.

The limb position sensor may comprise at least one of: a laser sensor and a lidar sensor.

The limb orientation sensor may comprise at least one of: an ultrasonic sensor and a radar sensor.

The limb gesture sensor may comprise at least one of: an optical sensor, a laser sensor, a lidar sensor, a radar sensor and an ultrasonic sensor.

The output device may output the indication using an audio, visual and/or haptic output.

The output device may output the indication by transmitting data to one or more remote devices.

The sliding component may comprise a sliding surface and the sliding surface may comprise at least one of: a streamline or round shape, a substantially convex cross-sectional or flat shape, a surface substantially devoid of protrusions, a surface including or substantially devoid of recessions, and a material having a lower coefficient of friction than the separate surface.

The force sensor may be configured to determine a weight applied to a first side of the device and the sliding component may be located at a second side of the device opposite to the first side.

The limb exercise device may comprise one or more further sensors, optionally, wherein the one or more further sensors are configured to measure at least one of: movement, acceleration, orientation and stability of the limb exercise device or the limb.

The limb exercise device may be for performing and monitoring limb exercises.

The limb exercise device of may be configured, when in use: such that the device is slidable along the separate surface to facilitate a bending of the limb, to determine a raising of the limb,
to measure a degree of swinging of the limb, to determine a position of the limb in 3D space,
to determine a rotation of the limb, to determine an instability of the limb, a gesture of the limb, or any combination of the above.

The output device may be configured to communicate with at least one of: one or more sensors remote of the device, another limb exercise device and one or more remote devices.

The one or more sensors remote of the device may be configured to measure at least one of: movement, acceleration, orientation, gesture, and stability of the limb.

In an aspect, there is provided a system comprising: the limb exercise device as described above; and one or more further sensors, remote of the device.

The one or more further sensors may be configured to be attachable to a limb of a user.

The limb exercise device and the one or more further sensors may be configured to transmit a signal to and/or receive a signal from one or more remote devices.

In an aspect, there is provided a method of using a limb exercise device, the limb exercise device comprising: a force sensor configured to determine a weight applied to the device; a sliding component configured to facilitate the sliding movement of the device along a separate surface, wherein the separate surface is a surface that is separate to the device, wherein the sliding component comprises a part of an external housing of the device; a device movement sensor configured to determine a movement of the device on the separate surface; a limb position sensor configured to determine a position, in at least one dimension, of a limb of a user positioned above or adjacent to the device; and an output device configured to output an indication in dependence on a signal from at least one of: the force sensor, the device movement sensor and the limb position sensor; the method comprising: receiving a signal indicating one or more of: a force applied to the device, by the force sensor; a device movement, by the device movement sensor; and a limb position, by the limb position sensor; and outputting an indication, by the output device, in dependence on the received one or more signals.

In an aspect, there is provided a computer readable medium storing computer program code which, when run on a processor, is configured to: receive an input signal from a limb exercising device, the device comprising: a force sensor configured to determine a weight applied to the device; a sliding component configured to facilitate the sliding movement of the device along a separate surface, wherein the separate surface is a surface that is separate to the device, wherein the sliding component comprises a part of an external housing of the device; a device movement sensor configured to determine a movement of the device on the separate surface; a limb position sensor configured to determine a position, in at least one dimension, of a limb of a user positioned above or adjacent to the device; and an output device configured to: output an indication in dependence on a signal from at least one of: the force sensor, the device movement sensor and the limb position sensor; the input signal indicating one or more of: a force applied to the device, by the force sensor; a device movement, by the device movement sensor; and a limb position, by the limb position sensor; and transmit an output indication in dependence on the received one or more signals.

In an aspect of the invention, there is provided a computer readable medium storing computer program code which, when run on a processor of a limb exercise device the limb exercise device comprising: a force sensor configured to determine a weight applied to the device; a sliding component configured to facilitate the sliding movement of the device along a separate surface, wherein the separate surface is a surface that is separate to the device, wherein the sliding component comprises a part of an external housing of the device; a device movement sensor configured to determine a movement of the device on the separate surface; a limb position sensor configured to determine a position, in at least one dimension, of a limb of a user positioned above or adjacent to the device; and an output device; wherein the processor is configured to: receive an input signal indicating one or more of: a weight applied to the device, from the force sensor; a device movement, from the device movement sensor; and a limb position, from the limb position sensor, and transmit an output indication to the output device of the limb exercise device in dependence on the input signal from at least one of: the force sensor, the device movement sensor and the limb position sensor.

### BRIEF DESCRIPTION OF THE DRAWINGS

For a better understanding of various examples of embodiments of the present invention reference will now be made, by way of example only, to the accompanying drawings in which:

FIG. 1 schematically illustrates a limb exercise device according to embodiments of the invention;

FIG. 2 schematically illustrates a side view of a limb exercise device according to embodiments of the invention;

FIGS. 3a, 3b and 3c schematically illustrate a use of embodiments of the invention;

FIG. 4 schematically illustrates a limb exercise device according to embodiments of the invention;

FIGS. 5a and 5b schematically illustrate a use of embodiments of the invention;

FIG. 6 schematically illustrates a block diagram of a device according to an embodiment of the invention; and

FIG. 7 schematically illustrates a flow chart of a method according to an embodiment of the invention.

### DESCRIPTION

In the following description, although embodiments of the device are described in terms of comprising various components, it should be understood that the components may be embodied as or otherwise controlled by a corresponding processing element or processor of the device. In this regard, each of the components described below may be one or more devices, means or circuitry embodied in hardware, software or a combination of hardware and software that is configured to perform the corresponding functions of the respective components as described in greater detail below.

Certain embodiments of the invention provide an improved apparatus that can facilitate the performance of various limb exercises as well as monitor the same, thereby aiding rehabilitation and training/prehabilitation of a user's limb. Limb exercises may include, for example, ‘straight leg lifts', 'knee bends’and ‘leg swings’.

Various non-limiting embodiments of the present invention seek to provide a device, system, method of using a device and a computer program for controlling a device for performing and monitoring leg exercises, and encouraging exercises through the performance of specially designed games.

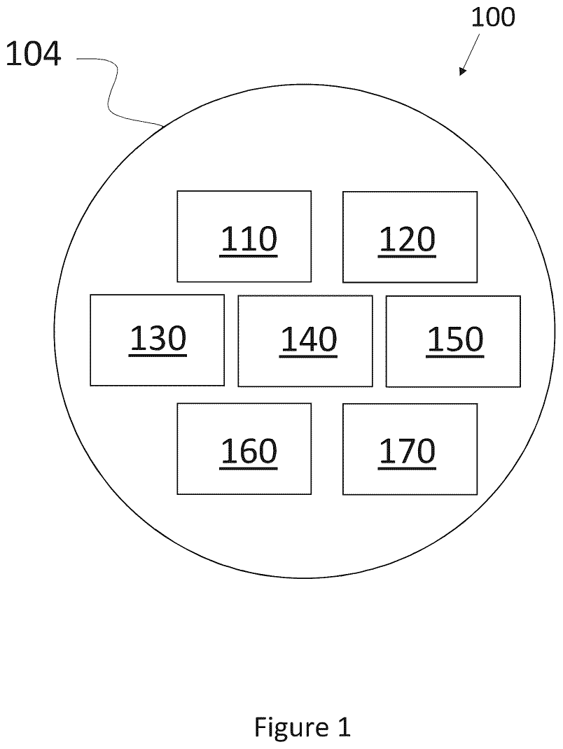

FIG. 1 schematically illustrates a limb exercise device 100 according to embodiments of the invention. In FIG. 1, there is provided a limb exercise device, indicated generally by reference numeral 100 comprising: a force sensor 110, a sliding component 120, a device movement sensor 130, a limb position sensor 140 and an output device 150. In this example, a device housing 104 is also illustrated (e.g. a casing or other structure in/on which the illustrated components are housed/mounted).

The force sensor 110 is configured to determine a weight applied to the device 100, for example such as a user placing his/her heel on top of the device 100. The weight may correspond to at least a portion of a user's limb, such as a user's heel being placed upon/resting on an upper surface of the device 100. In some examples, the force sensor 110 may comprise a pressure detector or an equivalent structure.

In one embodiment the force sensor 110 comprises a capacitive sensor comprising two capacitive plates configured such that a separation between the plates is proportional to a weight applied to the device 100 i.e. such that a minimum plate separation distance is provided when there is no weight/force applied to the device. Accordingly, a detection that the weight/load has been removed from the device 100 is determined when the capacitive sensor indicates a minimum plate separation.

The force sensor 110 may determine a weight applied to the device 100 by determining a presence of the weight applied to the device 100. The force sensor 110 may output a signal indicative of the presence of the weight applied to the device 100. Alternatively, the force sensor 110 may determine an actual value of the weight applied to the device 100 (e.g. 30 N in weight/force, or 5 kg in mass, since mass is linked to weight by the relation weight=mass×acceleration due to gravity). For example, the force sensor 110 may determine the weight of a user's limb applied to the device 100 and output a signal indicative of the weight of the user's limb.

The apparatus 100 also comprises, on its lower surface, a sliding component 120 configured to facilitate the sliding movement of the device 100 along a separate surface, wherein the separate surface is a surface separate of the device 100. The sliding component 120 may be configured, such as via its shape and/or material, so as to enable and facilitate the device 100 sliding along the separate surface. The device 100 may be placed on the separate surface and moved on the separate surface by the user. The sliding component 120 may be configured so as to facilitate the device 100 to slide along, skid across or glide over the separate surface, thereby enabling translational movement of the apparatus along the separate surface by sliding/skidding/gliding of the device 100 across the separate surface. The sliding component 120 may be configured so as to facilitate the device 100 to slide along, skid across or glide over the separate surface, thereby enabling rotational movement of the device 100 along the separate surface by sliding/skidding/gliding of the device 100 across the separate surface. For example, the sliding component may comprise a caterpillar track, roller, ball bearing, smooth surface or other component movable with respect to the body of the device 100 to facilitate device movement.

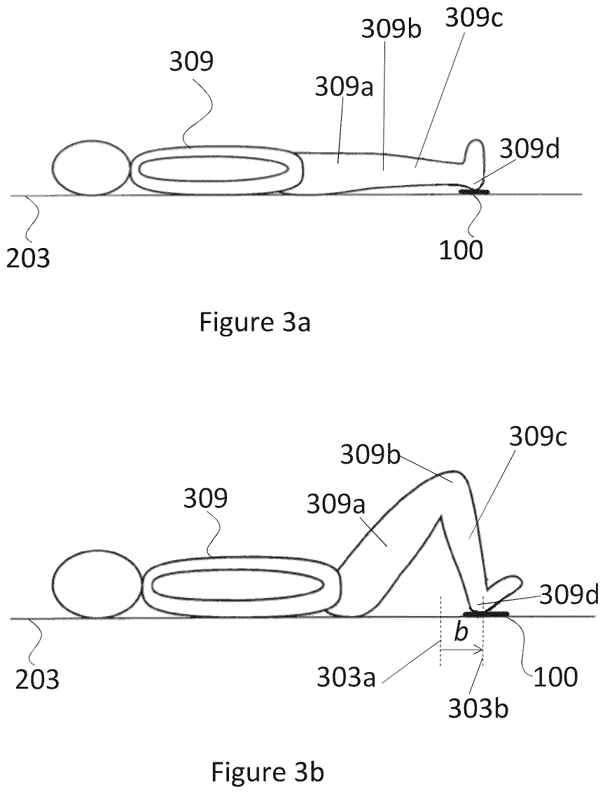

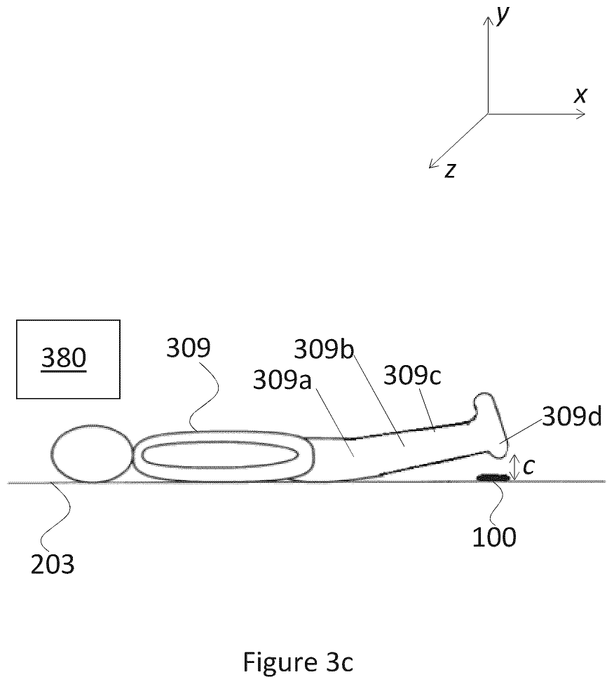

The device 100 comprises the device movement sensor 130 which is configured to determine a movement of the device 100 on the separate surface. The device movement sensor 130 may comprise an optical sensor in some examples (e.g. an LED, CMOS sensor and/or a camera). For example, the device movement sensor 130 may be a camera with infra-red, visible light or laser illumination with software to track movement of an image acquired by the camera. The device movement sensor 130 may determine a movement of the device 100 directly or indirectly. The device movement sensor 130 may determine the movement using an accelerometer or other such device that measures the movement directly. In order to determine the movement of the device 100 directly, the device movement sensor 130 may measure variables associated with the movement itself, such as velocity and/or acceleration. In order to determine the movement of the device 100 indirectly, the device movement sensor 130 may measure variables associated with the position of the device 100 before and after the movement, as will be explained in relation to FIG. 3b. In this way, the device movement sensor 130 may be configured to determine at least one of: a translational movement of the device 100 on the separate surface and a rotational movement of the device 100 on the separate surface. The device movement sensor 130 may be configured to determine an orientation of the device 100 on the separate surface using a gyroscope or magnetometer.

The limb exercise device 100 of FIG. 1 comprises a limb position sensor 140. The limb position sensor 140 is configured to determine a position of a limb of a user positioned above or adjacent to the device 100. The limb position sensor 140 may comprise at least one of: a laser sensor and a lidar sensor. For example, the position of the limb may be the position when the user lifts his/her heel above the device and moves his/her leg, e.g. bending his/her knee. The limb position that is determined by the limb position sensor 140 may be a one-dimensional height above the device 100, wherein the height is a distance corresponding to position along a gravity vector. The limb position may be a two-dimensional position, wherein the separate surface is perpendicular or parallel to the gravity vector, for example, and the two-dimensional position is within a plane perpendicular or parallel to the separate surface. The limb position may be a position in three-dimensional space. The position may be a position relative to the device 100 or an absolute position in 3D space.

The device 100 comprises the output device 150 configured to output an indication in dependence on a signal, wherein the signal is from at least one of the force sensor 110, the device movement sensor 130 and the limb position sensor 140. The output device 150 may be at least one of an audio, visual or haptic output device to provide one of more of: audio, visual or haptic output based on the measurement signals from the sensors, for example via a speaker, display, mechanical actuator, or vibrator. For example, an output may be provided which is triggered in dependence on a signal from one of the sensors to provide feedback to a user related to the exercises being performed, such as horizontal movement of the device during a knee bend or detection of a straight leg lift. Such movements are discussed below with respect to FIGS. 3a-c and 5a-b. The device 100 itself may output the indication to directly provide the user with feedback relating to exercises being performed and monitored using the audio, visual or haptic output device.

Alternatively, or in addition, the output device 150 may output the indication for transmitting data from the device 100 to one or more remote devices. The remote device may comprise at least one of audio, visual or haptic output means to provide user feedback, tracking of progress and recording use of the device 100. For example, the output device 150 may comprise a communication module for outputting sensor signals to a remote device, such as via wired or wireless communication. The remote device may be any suitable device capable of receiving sensor signals and providing an output related to the same, for example: a portable hand held electronic device, a mobile phone, a tablet, a PDA, a television, a monitor, a laptop, a PC, a smartwatch, a user programmable consumer electronic device or a server. The remote device may have additional functions besides receiving and outputting information from the device 100. Advantageously, this leverages use of audio, visual or haptic output means provided on such (ubiquitous) remote devices, which a user may well already be in possession of. Also, off-loading user feedback output functionality to a remote device saves on the costs of components, complexity of manufacturing and space/size of the device 100 which would otherwise be required to providing such features and functionality within the device 100 itself.

The output device 150 may comprise a communication module and a transmitter, e.g. configured for short range ultrasound or wireless communication, such as: Bluetooth™ or infrared IRDA. The output device 150 may be configured for WLAN, Wi-Fi or any other suitable wireless data transfer protocol or by ultrasound transmission.

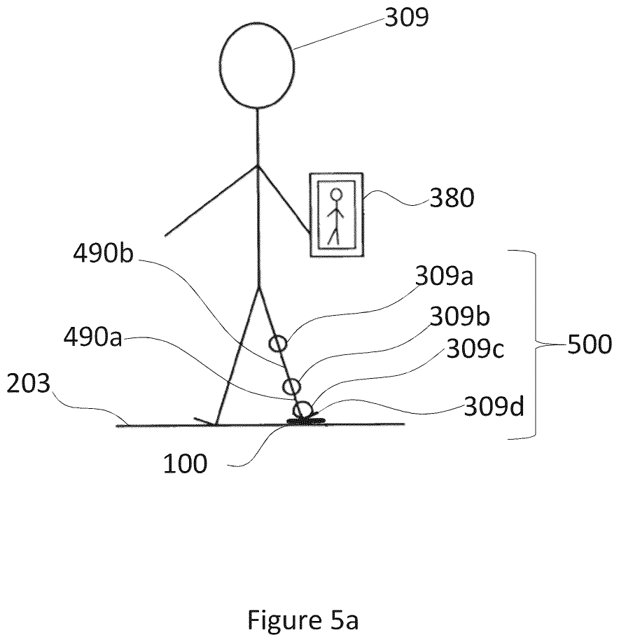

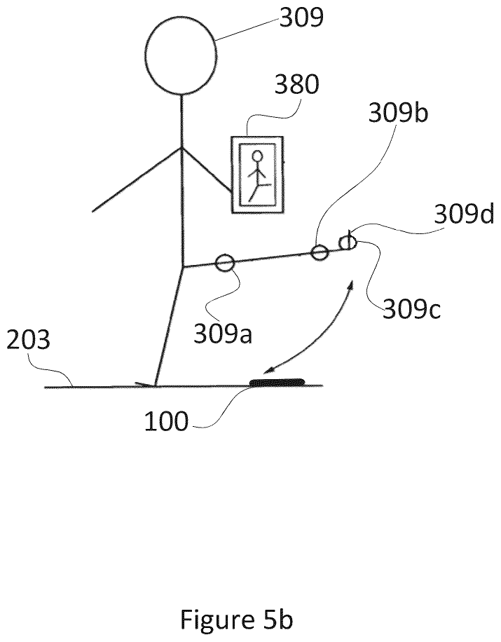

The output device 150 of the device 100 may be configured to communicate with at least one of: one or more sensors remote of the device, another limb exercise device and one or more remote device. For example, the communication module of the output device 150 may be configured to receive data from one or more sensors remote of the device, as will be explained in relation to FIG. 5. The communication module of the output device 150 may be configured to transmit and receive data from another limb exercise device or a remote device.

The device 100 may comprise both or one of a limb orientation sensor 160 and a limb gesture sensor 170. A limb orientation sensor 160 may be configured to determine an orientation of a limb of a user. The limb orientation sensor 160 may comprise at least one of: an ultrasonic sensor and a radar sensor. The limb orientation sensor 160 may be configured to determine the orientation of the limb by detecting the limb and identifying an orientation of the limb. For example, when the limb is detected, the detected orientation may be compared with a pre-stored database of limb orientations in order to identify the orientation of the limb. The pre-stored database of limb orientations may be stored on a memory (not illustrated) of the device 100 or external to and in communication with the device 100. That is, the detected orientation from the limb orientation sensor may be transmitted to a remote device and the detected orientation may be compared with a pre-stored database of limb orientations stored on the remote device.

The limb gesture sensor 170 may be configured to determine a gesture of the limb of the user. The limb gesture sensor 170 may comprise at least one of: an optical sensor, a laser sensor, a lidar sensor, a radar sensor and an ultrasonic sensor. The limb gesture sensor 170 may be configured to determine the gesture of the limb by detecting movement of the limb and identifying a gesture performed by the limb. For example, when the movement of the limb is detected, the detected movement may be compared with a pre-stored database of limb gestures in order to identify the gesture performed by the limb. The pre-stored database of limb gestures may be stored on the memory of the device 100. Alternatively, the detected movement from the limb gesture sensor may be transmitted to a remote device and the detected movement may be compared with a pre-stored database of limb gestures stored on the remote device.

At least one of the force sensor 110, the device movement sensor 130, the limb position sensor 140, the limb orientation sensor 160 and the limb gesture sensor 170 may be implemented by one or more controllers. The one or more controllers may be implemented by a processor.

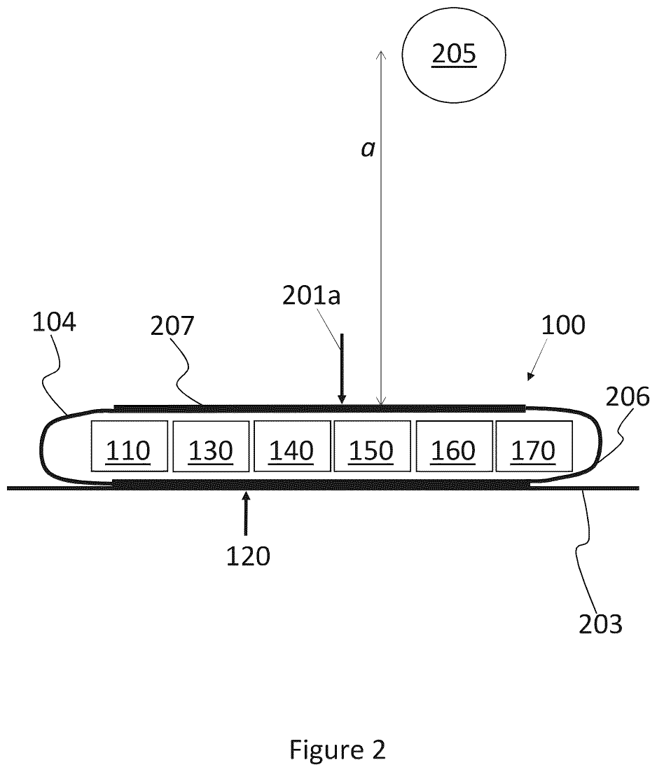

FIG. 2 illustrates a side view of an example limb exercise device 100 positioned on a separate surface 203, which comprises the sliding component 120 according to embodiments of the invention. Features in common with FIG. 1 will not be discussed again in detail.

The sliding component 120 may comprise a sliding surface, i.e. an external surface which, in use, is in contact with the separate surface 203 (such as a floor, exercise mat, step, or other surface). The separate surface 203 need not be flat/horizontal (i.e. perpendicular to the gravity vector) and may take any orientation. The separate surface 203 need not be planar and may have a non-planar surface in some examples. The sliding component 120 comprises a part of an external housing 104 of the device 100 in this example.

The sliding component 120 in some examples may comprise a rim or edge portion 206 which, when in use, is curved upwardly away from the separate surface 203. Furthermore, the sliding component 120 in some examples may be substantially devoid of protrusions or recessions so as to avoid the device 100 from snagging or catching on the separate surface 203 and to facilitate the device's sliding across the surface 203. In some examples, the sliding component 120 may comprise protrusions and/or indentations (e.g. ridges, bobbles, and/or other profile shape features). The sliding component 120 in some examples may protrude from the external housing 104 and contact the separate surface 203, for example have an overall planar form which is out of the plane of the housing 104 of the device 100. The sliding component 120 in some examples may be substantially co-planar with the external housing 104 and may contact the separate surface 203, for example through protrusions from the plane of the sliding component 120.

The sliding component 120 may be configured so as to have, for example, at least one of: a streamline shape, a substantially convex cross-sectional shape, and a substantially smooth surface. The sliding component 120 may be substantially free from deformations and perturbations and have a low surface roughness. The sliding component 120 may be made of a material that has a static and/or dynamic coefficient of friction with respect to the separate surface of: less than 0.5, or preferably less than 0.2, or more preferably less than 0.1 or yet more preferably less than 0.05.

As shown as FIG. 2, the force sensor 110 may be configured to determine a weight 201a applied to a first side of the device 100. The sliding component 120 may be located at a second side of the device 100 opposite to the first side.

In FIG. 2, an example position 205 of the limb of the user above the device 100 is illustrated. The limb position sensor 140 may be configured to determine the position 205 of the limb in one-dimension as illustrated by arrow a which is parallel to gravity and perpendicular, in this example, to the separate surface 203. The arrow a may be indicative of a height of the limb above the device 100. The limb position sensor 140 may be configured to determine the position 205 of the limb in two-dimensions in a plane perpendicular to arrow a. The limb position sensor 140 may be configured to determine the position 205 of the limb in three-dimensions i.e. with respect to a defined origin such as a centre point of the device 100. For example, the limb position sensor may comprise a radar or lidar sensor.

Although the arrow a illustrates that the position 205 relative to the device 100 is determined from the surface of the housing 104, the limb position sensor 140 may be configured to determine the position relative to the separate surface 203, or from another position relative to the device 100, in other examples.

FIG. 2 also illustrates, on the upper surface of device 100, a coupling component 207 for coupling the device 100 to at least a portion of a limb of a user (not shown) or for engaging the device 100 with the limb portion. The limb portion may correspond to a leg or a heel of a user (when with or without clothing/footwear). The coupling component 207 may comprise an exterior surface having a substantially concave shape. Its cross-sectional shape may be substantially concave so as to form a depressed/recessed area with respect to the circumferential rim portion 206 of the device 100. The depressed area may be configured in a shape complementary to the limb portion that is to be received, such as a heel of a user, so that the limb portion can abut against or mate within the concave surface.

The flat exterior surface or the depressed area may further comprise cushioning or a deformable material that can mould/form around the shape of the limb portion to provide a secure and comfortable nest for the limb portion. Furthermore, the flat exterior surface or the depressed area may comprise a grip/non-slip surface by which to engage with the limb portion and provide a form of frictional coupling of the limb portion to the device 100, such that the frictional force between the limb portion and the coupling component 207 is greater than the frictional force between the sliding component 120 and the separate surface 203. Advantageously, this means that when a horizontal translational force is applied by the limb portion to the device 100, the limb portion stays attached to the device 100 and does not slide off, but instead the device 100 slides across the separate surface 203, i.e. the device 100 is dragged across the separate surface 203 by the limb portion.

The coupling component 207 for coupling the device 100 to a portion of a limb of a user may further comprise securing means (not illustrated) to attach the device 100 to the limb portion. The securing means may comprise any suitable means for releasably attaching the limb portion to the device 100, for example so as to enable the device 100 to remain coupled to the user's limb portion even when the limb portion is raised off the ground. The securing means may comprise a fastener. The securing means may comprise a member such as a strap which goes around the limb portion and is secured to the device 100 at attachment points (not illustrated).

Although FIGS. 1 and 2 illustrate each sensor as being implemented on a separate sensor, it will be appreciated that at least two of the sensors may be implemented on a common sensor. In an embodiment, the limb position sensor 140 and the limb orientation sensor 160 may be implemented on a common sensor. In another embodiment, the limb position sensor 140 and the limb gesture sensor 170 may be implemented on a common sensor. In a further embodiment, the limb orientation sensor 160 and the limb gesture sensor 170 may be implemented on a common sensor. In some embodiments, the limb position sensor 140, the limb orientation sensor 160 and the limb gesture sensor 170 may be implemented on a common sensor.

For the purposes of describing the invention, the device movement sensor 130, the limb position sensor 140, the limb orientation sensor 160 and/or the limb gesture sensor 170 will be collectively referred to as ‘at least one sensor’.

In some embodiments, the at least one sensor may be configured to transmit radiation and receive reflected radiation from the limb. The radiation transmitted and received by the at least one sensor may be electromagnetic radiation, such as, infrared radiation or visible radiation. Alternatively, or in addition, the radiation transmitted and received by the at least one sensor may be sound radiation.

Each of the at least one sensor may be a different type of sensor or may be a similar or same type of sensor. Various types of sensors have been described; however, it will be appreciated that other types of sensors for each sensor may be envisaged.

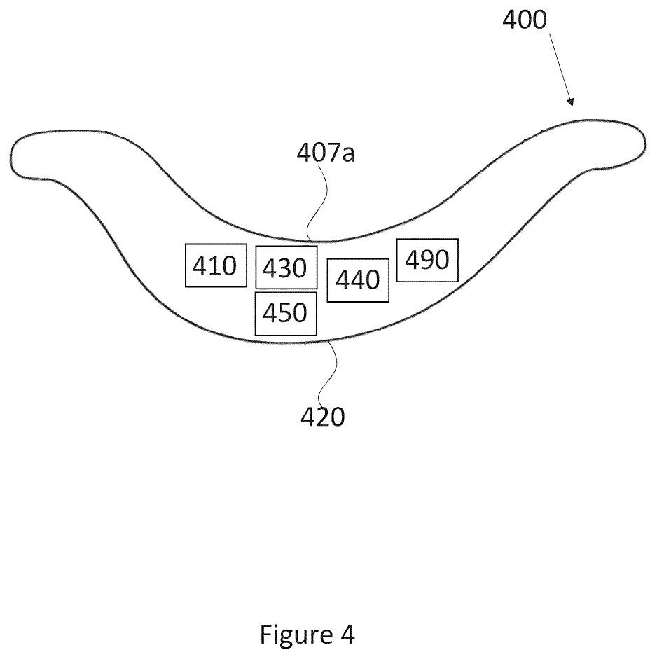

Although the device 100 is illustrated as partially cylindrical in FIGS. 1 and 2, the device 100 may have any shape and is not limited thereto. For example, the device 100 may take on a substantially “saucer-like” shape with its concave surface on the upper side of the device 100 opposite to the convex sliding surface 120 on the lower side as in FIG. 4. The device 100 may have rounded or flat edges and faces and/or may have parallel or non-parallel sides in some examples.

The device 100 may be configured such that, when in use, the device is slidable along the separate surface 203 to facilitate a bending of the limb, to determine a raising of the limb, to measure a degree of swinging of the limb, to determine a position of the limb in 3D space, to determine a rotation of the limb, to determine an instability of the limb, to determine a gesture of the limb, or any combination of the above.

For example, a user may lie flat on their back and slide their heel along the separate surface 203 which will cause their knee to bend. In other examples, the user may lie flat on their back with their legs stretched out completely and their heel resting on the limb exercise device. The user may then lift their leg pivoting from their hips and the device may determine that the user's foot has been raised and/or rotated, determine a swing of the foot, determine a position of the foot in 3D space and/or determine an instability of the limb.

FIGS. 3a and 3b schematically illustrate a use of embodiments of the limb exercise device 100, in particular in facilitating the performance of ‘knee bend’exercises.

As shown in FIG. 3a, a user 309 is lying down on the separate surface 203. For example, the user may be lying on the ground or on a bed, such that the separate surface 203 may comprise, for example, a carpet or other flooring material or bed sheets or other bedding material. Initially, the user's upper leg 309a, knee 309b and lower leg 309c are straight and the device 100 is placed beneath the user's heel 309d such that the device's sliding component 207 is in contact with the separate surface 203. In this state, a downwards force due to the weight of the user's heel 309d is applied to the device 100. This is balanced by a reaction force in an upwards direction from the separate surface 203. The force sensor 110 of the device 100 determined the weight of the user's limb and is thereby able to determine that the limb is resting on the device 100. In some embodiments, the force sensor 110 of the device 100 may determine the actual weight of the limb resting on the device 100.

As shown in FIG. 3b, when a user bends his/her knee 309b whilst keeping his/her heel 309d on the device 100, which may comprise keeping his/her heel 309d within the coupling component 207, this act applies a translational horizontal force, indicated by arrow b, to the device 100 via the user's heel 309d. This causes the device 100 to be dragged away from the user 309, i.e. from initial position 303a to 303b. The device 100 slides/skids/glides across the separate surface 203 via its sliding component 120 when dragged along by the user's heel 309d.

The device movement sensor 130 is configured to determine the movement of the device 100. The device movement sensor 130 may determine the movement using an accelerometer, as discussed above, or other such device that measures the movement directly. Alternatively, the device movement sensor 130 may determine the initial position 303a of the device 100 and the final position 303b of the device after the movement and determine the movement of the device 100 based on the positions.

FIG. 3c schematically illustrates a use of the limb exercise device 100, in particular in facilitating the detection and/or monitoring of ‘straight leg lift’ exercises, wherein at least the entire lower leg is raised as a straight unit.

As shown in FIG. 3c, when the user 309 raises his/her leg keeping it straight, a translational vertical force is applied to his/her heel 309d. This causes the weight of the heel 309d to gradually be removed from the device 100. When the downwards forces due to the weight of the user's heel 309d and the reaction force in an upwards direction from the separate surface 203 are no longer detected, the force sensor 110 may determine that the weight of the user's limb has been removed, that the limb has been raised up, and is no longer resting on the device 100. The force sensor 110 may determines that the user's limb portion has been lifted off the device 100 and thus may transmit an indication to that effect to the remote device 380, via the output device 150, to provide an output for user feedback.

When the user's leg is raised above the device, as shown in FIG. 3c, the heel 309d of the user is suspended above the device 100. The limb position sensor 140 may be configured to determine the position of the limb above the device 100. For example, the limb position sensor 140 may determine that the heel 309d is at a position of height c above the device 100, in a y direction (i.e. vertically, parallel to gravity) as shown by the axes in FIG. 3c. 100. The limb sensor, comprising a sensor that is configured to detect positions of objects within a given surrounding, such as a radar or lidar sensor may determine the position of the heel 309d in the x and y direction, x and z direction or y and z direction or may determine the position of the heel 309d in three-dimensions.

The limb position sensor 140 may be used to determine movement of the limb. For example, if the position detected by the limb position sensor 140 changes, then the limb position sensor 140 may determine that the limb was moved.

When the device 100 comprises the limb orientation sensor 160, the limb orientation sensor 160 may determine an orientation of the user's heel 309d or the user's foot as whole. For example, a direction that the user's foot is pointed towards may be determined by the limb orientation sensor based on a detection of the user's heel 309d being rotated left or right and detection of whether the heel 309d is bent or stretched.

When the device 100 comprises the limb gesture sensor 170, the limb gesture sensor 170 may determine a gesture performed by the user's heel 309d or the user's limb as a whole, or a part thereof. For example, the user may rotate their heel 309d or bend/flex their heel 309d and the limb gesture sensor 170 may determine that said rotation or bending of the heel has occurred. The limb gesture sensor (e.g. a camera, laser sensor, lidar sensor, radar sensor or ultrasonic sensor) may determine a movement of the limb as the gesture. For example, the gesture may be a raising or lowering or lateral movement of the limb.

An indication from the force sensor 110, the device movement sensor 130, the limb position sensor 140, the limb orientation sensor 160 and/or the limb gesture sensor 170 may be wirelessly transmitted to a remote device 380 via the output device 150 of the device 100. The remote device 380 may be configured to receive the indication from the device 100 and generate an output based on the same so as to provide feedback to a user 309 that he/she has successfully performed a straight leg lift and raised his/her leg up. Alternatively, where the device 100 comprises its own on-board audio, visual or haptic output means, this could be triggered, e.g. an aural, visual or haptic alert, and emitted to provide feedback to the user informing the user 309 that a straight leg lift has been accomplished.

FIG. 4 schematically illustrates a limb exercise device 400 according to a further embodiment of the invention. This device 400 is a substantially “saucer-like” shape with its concave surface 407a on an upper side of the device 400 opposite to a sliding surface 420 on the lower side.

The device 400 comprises a force sensor 410, the sliding surface as a sliding component 420, a device movement sensor 430, a limb position sensor 440 and an output device 450. The device 400 may also comprise a limb orientation sensor and a limb gesture sensor. The device 400 further comprises one or more further sensors 490. The output device 450 is configured to receive signals from the force sensor 410, device movement sensor 430 and limb position sensor 440 as well as the one or more further sensors 490. The one or more further sensors 490 may measure other variables associated with the device 400 or the limb of the user, such as movement, acceleration, orientation or stability of the device 100 or the user 309 and provide indications relating to the same to the output device 150. The one or more further sensors 490 may comprise, for example, accelerometers or gyroscopes.

A device 400 having a concave shape as in FIG. 4 may be used, for example, in cases where the user is required to rest their heel within/on the device 400 to slide the device 400 along the separate surface via the sliding surface 420 of the device 400. In this case, the concave surface 407a may act as a coupling component, in which the user's limb is coupled to the device 400 in the sense that it rests within a depression of the concave surface 407a.

FIGS. 5a and 5b schematically illustrate a use of embodiments of the invention, such as the limb exercise device 100 or 400, in particular in detecting and/or monitoring of ‘leg swing’ exercises and the degree of leg swing. The user is holding a remote device 380 which can operate in communication with the device 100. The remote device 380 may be, for example, a smart phone, smart watch, tablet computer, or other personal mobile electronic device.

As shown in FIG. 5a, the user 309 is standing upright with the user's upper leg 309a, knee 309b and lower leg 309c all substantially straight and vertically aligned. The device 100 is placed beneath the user's heel 309d. Further additional sensors 490a and 490b separate from and remote of the device 100 are attachable to the user's limb, such as at the upper leg 309a and lower leg 309c. These additional sensors are configured to measure and/or detect at least one of: movement, acceleration, orientation, gestures, and stability of the user's limb. The additional sensors remote of the device 100 may comprise, for example, an accelerometer, a gyroscope or a goniometer. Furthermore, the sensors are configured to transmit signals related to their measurements to the remote device 380 or the limb exercise device 100.

This system 500, comprising the device 100 and the additional sensors 490a, 490b, enables a determination and monitoring of gestures and a degree of swinging of the leg. Signals relating to this as detected by the sensors 490a, 490b, are transmitted to the remote device 380 or the limb exercise device 100, and the receiving device 380, 100 may provide feedback, such as visual feedback as shown in the figures, to the user 309. The feedback may be for example, a visual indication of the user's movement (e.g. a displayed cartoon figure displaying moving their leg to mirror the user's real world movements). As another example, the displayed feedback may indicate the user's real world movement on the display screen of the device 380 in a “virtual reality” or “augmented reality” type display, in which other elements (e.g. game items such as a football, a punchbag) are shown on the display and which are shown to move in a way corresponding to the user's real world movement. Such examples may provide intuitive feedback to encourage the user to perform the exercise correctly, and may provide a stimulation or incentive for the user to perform the exercises (e.g. to reach a high score). In this way, the device 100 may be used for games for enhancement of the exercises or for enjoyment or both.

When the user 309 swings his/her leg as shown in FIG. 5b, the force sensor, the limb position sensor, the limb orientation sensor and/or the limb gesture sensor of the device 100 may operate as described above in relation to FIG. 3c to determine that the user's leg has lifted, and/or to detect the movement of the user's leg lifting from the device 100. In addition, the output device of the device 100 may operate as described above in relation to FIG. 3c to provide an output for user feedback, for example to the remote device 380.

The device 100 may be configured to combine data from the additional sensors remote of the device 100 and at least one of the force sensor 110, the device movement sensor 130, the limb position sensor 140, the limb orientation sensor 160 and the limb gesture sensor 170 to determine a movement, position, orientation and/or gesture of the limb and/or device, respectively.

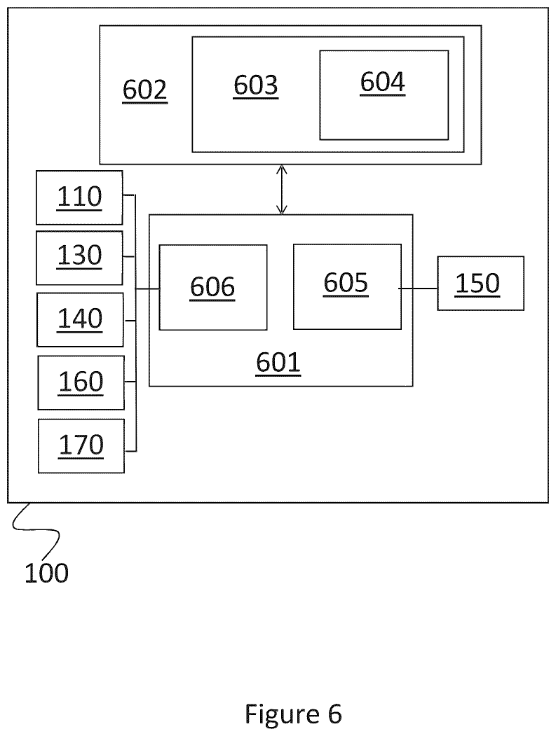

FIG. 6 schematically illustrates a block diagram of an embodiment of the limb exercise device 100. The device 100 may take the form of a medical device or an exercise device. The device 100 comprises a controller such as a processor 601 and a memory 602 including computer program 603 comprising computer program instructions 604. The processor may also comprise an output interface 605 via which data and/or commands are output by the processor and an input interface 606 via which data and/or commands are input to the processor.

Implementation of controller can be in hardware alone (a circuit), have certain aspects in software including firmware alone or can be a combination of hardware and software (including firmware). The computer program 603 may be stored on a computer readable storage medium 607 (disk, memory etc).

The device 100 further comprises: the force sensor 110, the device movement sensor 130, the limb position sensor 140, the limb orientation sensor 160 and the limb gesture sensor 170 and an output device 150. The output device 150 may comprise a transceiver configured for wireless communication with a remote device (not shown). The output device 150 may comprise audio, visual and haptic output devices. Although FIG. 6 illustrates one output device 150, it will be appreciated that the device 100 may comprise a plurality of output devices.

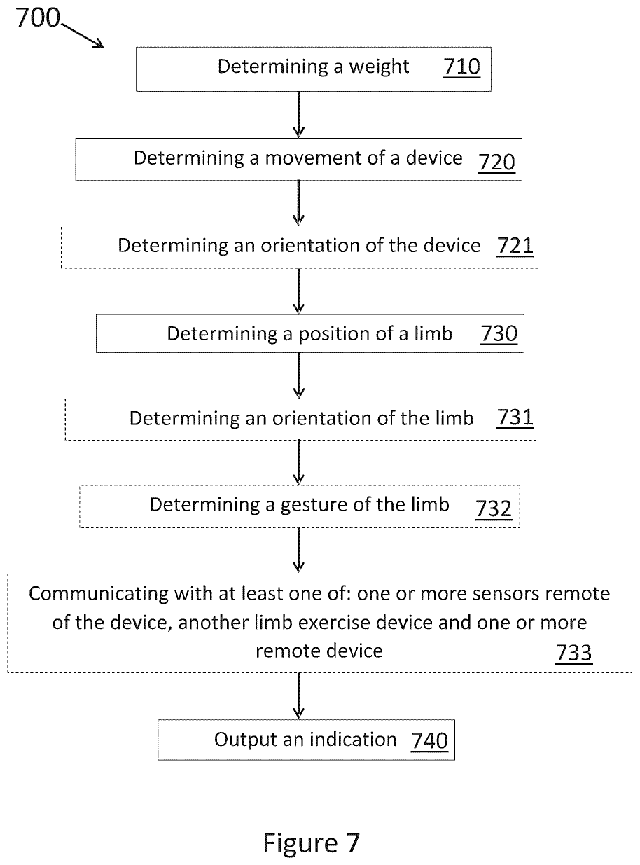

The computer program 603 comprises computer program instructions 604 that control the operation of the device 100 when loaded into the processor 601. The computer program instructions provide the logic and routines that enables the device 100 to perform any method disclosed herein, such as the method described below in relation to FIG. 7. The computer instructions may provide the logic and routines that enables the device 100 to learn from data collected from an individual or multiple users to optimise, individualise and improve function of the device 100 using advanced data analytical techniques such as, but not restricted to, machine learning, and artificial intelligence. The computer program 603 may be resident on the device 100, or located on one or more remote machines, or on the ‘cloud’.

FIG. 7 schematically illustrates a flow chart of a method 700 according to an embodiment of the invention. The method 700 may be performed by the limb exercise device 100, 400.

Method step 710 comprises determining a weight applied to the device 100. The determining 710 of the weight applied to the device 100 may comprise determining a presence of the weight applied to the device 100. Alternatively, the determining 710 of the weight applied to the device 100 may comprise determining an actual value of the weight applied to the device 100.

Method step 720 comprises determining a movement of the device 100. The determining 720 of the movement of the device 100 may comprise determining the movement of the device 100 on a separate surface 203. The movement of the device 100 may be caused by a user sliding the device 100 along the separate surface 203. Method step 720 may comprise determining at least one of: a translational movement of the device 100 on the separate surface 203 and a rotational movement of the device 100 on the separate surface 203.

The method 700 may comprise method step 721 which comprises determining an orientation of the device 100 on the separate surface 203.

Method step 730 comprises determining a position of a limb of a user. The limb may be positioned above or adjacent to the device 100. The limb position may be determined in one, two or three dimensions. Method step 730 may comprise one or both of determining the position of the limb relative to the device from the surface of the housing 104 or the position of the limb relative to the separate surface 203.

Method step 740 comprises outputting an indication in dependence on a signal. The signal may be from at least one of: the force sensor 110, the device movement sensor 130 and the limb position sensor 140. The indication may be at least one of an audio, visual or haptic output to be outputted by the output device 150 or may be an indication for transmitting data from the device 100 to one or more remote devices.

The method 700 may further comprise method step 731 which comprises determining an orientation of the limb. The determining 731 of the orientation of the limb may comprise detecting the limb and identifying an orientation of the limb. The method step 731 may further comprise comparing data of the detected limb with a pre-stored database of limb orientations in order to identify the orientation of the limb.

The method 700 may comprise method step 732 which comprises determining a gesture of the limb of the user. The determining 732 of the gesture of the limb may comprise detecting movement of the limb and identifying a gesture performed by the limb. The method step 732 may further comprise comparing the detected movement with a pre-stored database of limb gestures in order to identify the gesture performed by the limb.

The method 700 may comprise method step 733 which comprises communicating with at least one of: one or more sensors remote of the device, another limb exercise device and one or more remote device.

It will be appreciated that the order of the method steps illustrated in method 700 are not intended to be limiting. The method steps may be performed in any order, as will be appreciated by the person skilled in the art.

The procedures described above may be embodied by computer program instructions. In this regard, the computer program instructions which embody the procedures described above may be stored by a memory storage of the remote device and performed by a processor of the remote device.

Embodiments of the invention have been described using schematic block diagrams and flowchart illustrations. It will be understood that various blocks can involve implementation by a combination of hardware and computer program instructions of a computer program. These program instructions may be provided to one or more controllers or processors such that the instructions which execute on the processor create means for implementing the functions specified in the block or blocks. The computer program instructions may be executed by the processor to cause a series of operational steps to be performed by the processor to produce a computer implemented process such that the instructions which execute on the processor provide steps for implementing the functions specified in the block or blocks.

Accordingly, the blocks support: combinations of means for performing the specified functions; combinations of steps for performing the specified functions; and computer program instructions for performing the specified functions. It will also be understood that each block, and combinations of blocks, can be implemented by special purpose hardware-based systems which perform the specified functions or steps, or combinations of special purpose hardware and computer program instructions.

In the description above, the wording ‘couple’ and ‘communication’ as well as their derivatives mean operationally connected and in operational communication respectively. It should be appreciated that any number or combination of intervening components can exist (including no intervening components). For example, the user's heel being coupled to the limb exercise device 100 encompasses a coupling of the user's limb both with and without socks and/or shoes on. The communication between the limb exercise device 100 and the remote device may be direct or indirect via other 3rd party devices, such as a router.

Embodiments of the present invention provide apparatus consisting of various modules or means that provide the functionality described above. The modules or means may be implemented as hardware, or may be implemented as software or firmware to be performed by a computer processor. In particular, in the case of firmware or software, embodiments of the invention can be provided as a computer program product including a computer readable storage structure embodying computer program code (i.e. the software or firmware) thereon for performing by the computer processor.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Although various embodiments of the present invention have been described in the preceding paragraphs with reference to various examples, it should be appreciated that modifications to the examples given can be made without departing from the scope of the invention as claimed. For example whilst embodiments have been described with respect to a leg exercise/monitoring device, it will be appreciated that embodiments could provide an exercise/monitor device for other limbs, such as portions of a user's arm.

1. A limb exercise device comprising:
a force sensor configured to determine a weight applied to the device;
a sliding component configured to facilitate a sliding movement of the device along a separate surface, wherein the separate surface is a surface that is separate to the device, wherein the sliding component comprises a part of an external housing of the device;
a device movement sensor configured to determine a movement of the device on the separate surface;
a limb position sensor configured to determine a position and a movement, in at least one dimension, of a limb of a user above or adjacent to the device; and
an output device configured to output an indication in dependence on a signal from one or more of: the force sensor, the device movement sensor, and the limb position sensor.

2. The limb exercise device of claim 1, wherein the output device is configured to output the indication in dependence on signals from the limb position sensor and one or more of the force sensor and the device movement sensor.

3. The limb exercise device of claim 1, wherein the output device is configured to output the indication in dependence on signals from the limb position sensor, the force sensor and the device movement sensor.

4. The limb exercise device of claim 1, wherein the sliding component is configured to facilitate one or more of: a translational movement of the device along the separate surface, and a rotational movement of the device on the separate surface.

5. The limb exercise device of claim 1, wherein the device movement sensor is configured to determine one or more of: a translational movement of the device on the separate surface and a rotational movement of the device on the separate surface.

6. The limb exercise device of claim 1, further comprising one or more of:
a limb orientation sensor configured to determine an orientation of the limb of the user; and
a limb gesture sensor configured to determine a gesture of the limb of the user.

7. (canceled)

8. The limb exercise device of claim 1, further comprising a limb orientation sensor configured to determine an orientation of the limb of the user and a limb gesture sensor configured to determine a gesture of the limb of the user, wherein one or more of: the device movement sensor, the limb position sensor, the limb orientation sensor, and the limb gesture sensor, is configured to transmit radiation and to receive reflected radiation from the limb.

9. (canceled)

10. The limb exercise device of claim 1, further comprising a limb orientation sensor configured to determine an orientation of the limb of the user, wherein the limb orientation sensor comprises one or more of: an ultrasonic sensor and a radar sensor.

11. The limb exercise device of claim 1, further comprising a limb gesture sensor configured to determine a gesture of the limb of the user, wherein the limb gesture sensor comprises one or more of: an optical sensor, a laser sensor, a lidar sensor, a radar sensor, and an ultrasonic sensor.

12. The limb exercise device of claim 1, wherein one or more of:
the output device is configured to output the indication using an audio, visual and haptic output; and
the output device is configured to output the indication by transmitting data to one or more remote devices.

13. The limb exercise device of claim 1, wherein the sliding component comprises a sliding surface and wherein the sliding surface comprises one or more of:
a streamline or round shape,
a substantially convex cross-sectional or flat shape,
a surface substantially devoid of protrusions,
a surface including or substantially devoid of recessions, and
a material having a lower coefficient of friction than the separate surface.

14. The limb exercise device of claim 1, wherein the force sensor is configured to determine the weight applied to a first side of the device, and wherein the sliding component is located at a second side of the device opposite to the first side.

15. The limb exercise device of claim 1, comprising one or more further sensors in addition to the device movement sensor, wherein the one or more further sensors, separate from the device movement sensor, are configured to measure one or more of: movement, acceleration, orientation and stability of the limb exercise device or the limb.

16. The limb exercise device of claim 1, wherein, the device is configured for one or more of:
to slide along the separate surface to facilitate a bending of the limb,
to determine a raising of the limb;
to measure a degree of swinging of the limb;
to determine a position of the limb in 3D space, to determine a rotation of the limb,
to determine an instability of the limb, and
to determine a gesture of the limb.

17. The limb exercise device of claim 1, wherein the output device is configured to communicate with one or more of: one or more sensors remote of the device, another limb exercise device, and one or more remote devices; wherein the one or more sensors remote of the device are configured to measure one or more of: a movement, an acceleration, an orientation, a gesture, and a stability of the limb.

18. A system comprising:
the limb exercise device of claim 1; and
one or more further sensors remote of the device;
wherein:
the one or more further sensors are configured to be attachable to the limb of the user; and
the limb exercise device and the one or more further sensors are configured to do one or more of: transmit a signal to one or more remote devices, and receive a signal from one or more remote devices.

19. A method of using a limb exercise device, the method comprising:
providing the limb exercise device, the limb exercise device comprising: a force sensor configured to determine a weight applied to the device; a sliding component configured to facilitate a sliding movement of the device along a separate surface, wherein the separate surface is a surface that is separate to the device, wherein the sliding component comprises a part of an external housing of the device; a device movement sensor configured to determine a movement of the device on the separate surface; a limb position sensor configured to determine a position and a movement, in at least one dimension, of a limb of a user above or adjacent to the device; and an output device configured to output an indication in dependence on a signal from one or more of: the force sensor, the device movement sensor, and the limb position sensor;
receiving an input signal indicating one or more of:
a weight applied to the device, from the force sensor;
a device movement, from the device movement sensor; and
a limb position, from the limb position sensor; and
outputting an output indication, by the output device, in dependence on the input signal.

20. A non-transitory computer readable medium storing computer program code which, when run on a processor of a limb exercise device having a force sensor configured to determine a weight applied to the device, a sliding component configured to facilitate a sliding movement of the device along a separate surface, wherein the separate surface is a surface that is separate to the device, wherein the sliding component comprises a part of an external housing of the device, a device movement sensor configured to determine a movement of the device on the separate surface, a limb position sensor configured to determine a position and a movement, in at least one dimension, of a limb of a user above or adjacent to the device, and an output device, causes the processor to:
receive an input signal indicating one or more of:
a weight applied to the device, from the force sensor;
a device movement, from the device movement sensor; and
a limb position and limb movement, from the limb position sensor, and transmit an output indication to the output device of the limb exercise device in dependence on the input signal.

21. An apparatus for exercising a limb of a user, comprising:
a body adapted to contact the limb of the user;
a force sensor configured to determine a weight applied to the body;
a sliding component configured to facilitate a sliding movement of the body along a separate surface, wherein the separate surface is a surface that is separate to the body, wherein the sliding component comprises a part of an external housing of the body;
a movement sensor configured to determine a movement of the body on the separate surface;
a limb position sensor for determining a position and a movement, in at least one dimension, of the limb of the user above or adjacent to the body; and
an output device configured to output an indication in dependence on a signal from one or more of: the force sensor, the movement sensor, and the limb position sensor.

22. A limb exercise device comprising:
a force sensor configured to determine a weight applied to the device;
a sliding component configured to facilitate a sliding movement of the device along a separate surface, wherein the separate surface is a surface that is separate to the device, wherein the sliding component comprises a part of an external housing of the device;
a device movement sensor configured to determine a movement of the device on the separate surface;
means for determining a position and a movement, in at least one dimension, of a limb of a user above or adjacent to the device; and
an output device configured to output an indication in dependence on a signal from one or more of: the force sensor, the device movement sensor, and the means for determining the limb position and movement.
